(19) United States
(12) Patent Application Publication
(10) Pub. No.: US 2026/0129399 A1
(43) Pub. Date: May 7, 2026

(54) METHODS FOR DETECTING WEARING POSITIONS OF EARPHONES, EARPHONES, AND ELECTRONIC DEVICES

(71) Applicant: SHENZHEN SHOKZ CO., LTD., Shenzhen (CN)

(72) Inventors: Libin ZHOU, Shenzhen (CN); Liang WANG, Shenzhen (CN)

(73) Assignee: SHENZHEN SHOKZ CO., LTD., Shenzhen (CN)

(21) Appl. No.: 19/435,644

(22) Filed: Dec. 29, 2025

Related U.S. Application Data
(63) Continuation of application No. PCT/CN2024/102591, filed on Jun. 28, 2024.

(51) Int. Cl. H04S 7/00; H04R 1/10

(52) U.S. Cl. CPC H04S 7/304; H04R 1/1016

(57) ABSTRACT

A method for detecting a wearing position of an earphone is provided. The earphone is provided with a detection module and stores a wearing position indication. For each of at least one detection cycle, a pre-judgment result indicating the wearing position of the earphone at the detection cycle is obtain ed via the detection module. The pre-judgment result indicates whether the earphone is worn on a left ear or a right ear. Real-time updating on the wearing position indication is performed based on a comparison result between each of the at least one pre-judgment result and a current wearing position indication of the earphone, wherein the wearing position indication indicates whether the earphone is worn on a left ear or a right ear.

### CROSS-REFERENCE TO RELATED APPLICATIONS

This application is a Continuation of International Patent Application No. PCT/CN2024/102591, filed on Jun. 28, 2024, the entire contents of which are incorporated herein by reference.

### TECHNICAL FIELD

The present disclosure generally relates to the field of consumer electronics, and in particular to a method for detecting a wearing position of an earphone, an earphone, and an electronic device.

### BACKGROUND

An earphone typically stores a wearing position indication. The wearing position indication is used to indicate whether the earphone is worn on the left ear or the right ear. In related technologies, the wearing position indication stored in the earphone is updated only once when the earphone is just taken out of an earphone case or just worn on the ear. This easily causes a situation where the wearing position indication does not match the actual wearing position, affecting the user experience.

### SUMMARY

One or more embodiments of the present disclosure provide a method for detecting a wearing position of an earphone. The earphone is provided with a detection module and stores a wearing position indication. The method includes: for each of at least one detection cycle, obtaining, via the detection module, a pre-judgment result indicating the wearing position of the earphone at the detection cycle, the pre-judgment result indicates whether the earphone is worn on a left ear or a right ear; performing real-time updating on the wearing position indication based on a comparison result between each of the at least one pre-judgment result and a current wearing position indication of the earphone, the wearing position indication indicates whether the earphone is worn on a left ear or a right ear.

In some embodiments, the detection module includes an accelerometer. The obtaining, via the detection module, a pre-judgment result indicating the wearing position of the earphone at the detection cycle comprises: obtaining the pre-judgment result at the detection cycle based on at least one set of acceleration values detected by the accelerometer.

In some embodiments, the detection module further includes a gyroscope. The obtaining, via the detection module, a pre-judgment result indicating the wearing position of the earphone at the detection cycle further includes: determining whether the pre-judgment result is in a valid state, wherein the pre-judgment result in the valid state indicates that the earphone is worn on one of the left ear and the right ear; and in response to determining that the pre-judgment result is not in the valid state, resetting the pre-judgment result according to an angular velocity value detected by the gyroscope when a user performs a preset head action.

In some embodiments, the method is started upon detection that the earphone is in a wearing state. The method is executed at a first detection frequency during a period between a point when the method is started and a preset time threshold. The method is executed at a second detection frequency after the preset time threshold, the first detection frequency being higher than the second detection frequency.

In some embodiments, the performing real-time updating on the wearing position indication based on a comparison result between each of the at least one pre-judgment result and a current wearing position indication of the earphone includes: determining, among a preset count of consecutive detection cycles, detection cycles whose the pre-judgment results are valid and different from the wearing position indication; in response to determining that the count of the determined detection cycles is greater than or equal to a preset count threshold, updating the wearing position indication to the pre-judgment results of the determined detection cycles, wherein the preset count of the consecutive detection cycles is greater than or equal to the preset count threshold.

In some embodiments, the performing real-time updating on the wearing position indication based on a comparison result between each of the at least one pre-judgment result and a current wearing position indication of the earphone includes: for each of the at least one detection cycle, determining a count of consecutive detection cycles whose the pre-judgment results are valid and different from the wearing position indication; in response to determining that the count is equal to a preset count threshold, updating the wearing position indication to the pre-judgment result of the detection cycle and resetting the count of consecutive detection cycles.

In some embodiments, the performing real-time updating on the wearing position indication based on a comparison result between each of the at least one pre-judgment result and a current wearing position indication of the earphone further includes: for each of the at least one detection cycle, in response to determining that the pre-judgment result of the detection cycle is valid and the same as the wearing position indication, or the pre-judgment result of the detection cycle is invalid, maintaining the wearing position indication and resetting the count of consecutive detection cycles.

In some embodiments, the obtaining the pre-judgment result at the detection cycle based on at least one set of acceleration values detected by the accelerometer includes: obtaining the pre-judgment result by inputting the at least one set of acceleration values obtained within the detection cycle into a trained neural network model.

In some embodiments, in response to determining that the earphone is placed into an earphone compartment of an earphone case, resetting, by the earphone case, the wearing position indication.

In some embodiments, there is a pair of earphones. The method further includes: in response to determining that the current wearing position indications of the pair of earphones indicate that the pair of earphones are worn on the same ear for a predetermined time, generating a reset reminder.

In some embodiments, there is a pair of earphones. The method further includes: in response to determining that the current wearing position indications of the pair of earphones indicate that the pair of earphones are worn on the same ear, and a generation time of the current wearing position indication of one of the pair of earphones is earlier than a generation time of the current wearing position indication of the other of the pair of earphones, maintaining the wearing position indication of the one of the pair of earphones unchanged and resetting the wearing position indication of the other of the pair of earphones.

In some embodiments, the duration of each detection cycle is in a range of 50 ms-10 s.

In some embodiments, the method further includes: generating an audio signal matching a corresponding audio channel of the earphone according to the wearing position indication; and/or setting a button function of the earphone according to the wearing position indication.

In some embodiments, the method further includes: issuing a reminder message for reminding a user of the wearing position indicated by the wearing position indication; determining whether to adapt an audio signal matching a corresponding audio channel of the earphone according to the wearing position indication based on a received preset trigger action of a user; and/or determining whether to set a button function of the earphone according to the wearing position indication based on the received preset trigger action of the user.

One or more embodiments of the present disclosure further provide an earphone. The earphone includes a processor and a storage device. The storage device stores a computer program. The processor is configured to execute the computer program to implement any one of the methods described above.

One or more embodiments of the present disclosure further provide an electronic device. The electronic device is configured to communicate with the earphone and includes a processor and a storage device. The storage device stores a computer program. The processor is configured to execute the computer program to implement any one of the methods described above.

In the method of some embodiments of the present description, when the earphone is in the wearing state, for each of the at least one detection cycle, the wearing position of the earphone is periodically detected, and the wearing position indication stored in the earphone is updated in real time. Compared with manners in related technologies, this is beneficial for reducing the risk of false detection and improving the accuracy of wearing position detection.

### BRIEF DESCRIPTION OF THE DRAWINGS

To more clearly illustrate the technical solutions in the embodiments of the present disclosure, the following briefly describes the accompanying drawings required for describing the embodiments. Obviously, the accompanying drawings in the following description show merely some embodiments of the present disclosure, and a person of ordinary skill in the art may derive other drawings from these accompanying drawings without creative efforts, wherein:

FIG. 1 is a schematic diagram illustrating a state in which an earphone is worn on an ear EAR of a user according to an embodiment of the present disclosure;

FIG. 2 is a flowchart of a detection method according to an embodiment of the present disclosure;

FIG. 3 is a flowchart of operation S100 according to an embodiment of the present disclosure;

FIG. 4 is a flowchart of operation S200 according to an embodiment of the present disclosure;

FIG. 5 is a flowchart of a detection method according to another embodiment of the present disclosure;

FIG. 6 is a flowchart of a detection method according to another embodiment of the present disclosure;

FIG. 7 is a flowchart of a detection method according to another embodiment of the present disclosure;

FIG. 8 is a block diagram of an earphone according to an embodiment of the present disclosure; and FIG. 9 is a block diagram of an electronic device according to an embodiment of the present disclosure.

### DETAILED DESCRIPTION

The present disclosure is further described in detail below with reference to the accompanying drawings and embodiments. It is specifically pointed out that the following embodiments are only used to illustrate the present disclosure, but do not limit the scope of the present disclosure. Similarly, the following embodiments are only some embodiments of the present disclosure rather than all embodiments. All other embodiments obtained by a person of ordinary skill in the art based on the embodiments of the present disclosure without creative efforts shall fall within the protection scope of the present disclosure.

The “embodiments” in the present disclosure means that specific features, structures, or characteristics described in conjunction with the embodiments can be included in at least one embodiment of the present disclosure. The phrase appearing in various positions in the specification does not necessarily refer to the same embodiment, nor is it an independent or alternative embodiment that is mutually exclusive with other embodiments. Those skilled in the art may explicitly and implicitly understand that the embodiments described in the present can be combined with other embodiments.

In the present disclosure, the terms “first”, “second”, and “third” are used for descriptive purposes only, and cannot be understood as indicating or implying relative importance or implicitly indicating the quantity of the indicated technical features. Thus, features defined with “first”, “second”, and “third” may explicitly or implicitly include at least one such feature. In the description of the present disclosure, the meaning of “a plurality of” is at least two, for example, two, three, etc., unless otherwise explicitly and specifically defined. The terms “include” and “comprise” and any variations thereof are intended to cover a non-exclusive inclusion. For example, a process, method, system, product, or device that includes a series of steps or units is not limited to the listed steps or units, but optionally also includes steps or units not listed, or optionally also includes other steps or units inherent to these processes, methods, products, or devices.

In one aspect, the present disclosure provides a method for detecting a wearing position of an earphone 1. The method may be performed by the earphone 1 itself, or may be performed by an electronic device in communication with the earphone 1. The electronic device may be a mobile phone, a tablet, or a computer. The present disclosure does not impose limitations in this regard, and a person skilled in the art may make a selection based on actual requirements.

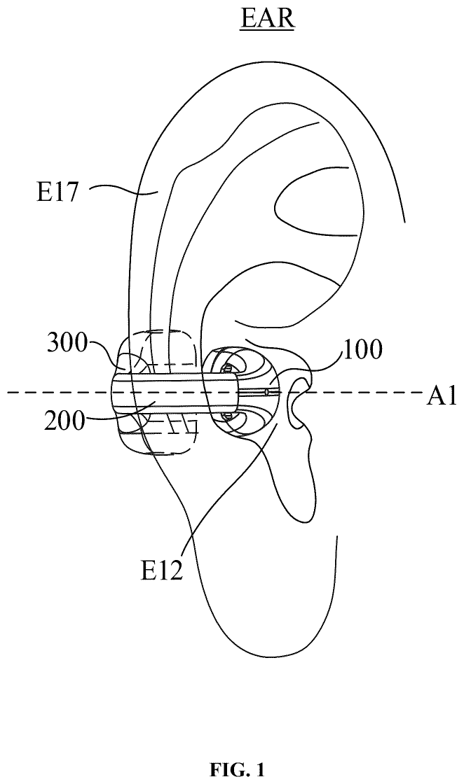

As shown in FIG. 1, FIG. 1 is a schematic diagram illustrating a state in which an earphone is worn on an ear EAR of a user according to an embodiment of the present disclosure. The earphone 1 may be an ear-clip type earphone. As shown in FIG. 1, the earphone 1 may include a sound generating portion 100 for insertion into a concha cavity E12 of a user, an abutting portion 300 for abutting behind the ear of the user, and an ear hook 200 connected between the sound generating portion 100 and the abutting portion 300. In a wearing state, the ear hook 200 may bypass a helix E17 of the user. The sound generating portion 100 and the abutting portion 300 form a clamping state on two sides of the helix E17 of the user, and the sound generating portion 100 is located within the concha cavity E12.

The sound generating portion 100 is a sound playback device configured to convert an electrical signal into a sound signal and play the sound signal to the wearer. The abutting portion 300 and the sound generating portion 100 form the clamping state to clamp and wear the entire earphone 1 on the ear of the user. A detection module and a storage module may be disposed in the abutting portion 300. The detection module is configured to obtain a wearing position of the earphone. The wearing position of the earphone includes a left ear and a right ear. The storage module may be configured to store a wearing position indication. The wearing position indication may be configured to indicate whether the earphone is worn on the left ear or the right ear.

In some embodiments, the detection module and the storage module may also be disposed in the sound generating portion 100. Alternatively, one of the detection module and the storage module may be disposed in the sound generating portion 100, and the other may be disposed in the abutting portion 300. The present disclosure does not impose limitations in this regard, and a person skilled in the art may make a selection based on actual requirements. In some embodiments, a battery, a circuit board, and other components may be disposed in the abutting portion 300. Certainly, the abutting portion 300 may not include the battery, and the battery may be installed in the sound generating portion 100. This falls within the scope easily understood by a person skilled in the art, and details are not described herein again.

As shown in FIG. 1, the ear hook 200 has a symmetry plane A1 arranged along a length direction of the ear hook 200. Specifically, the symmetry plane A1 of the ear hook 200 refers to a plane arranged along the length direction of the ear hook 200, and portions of the ear hook 200 on two sides of the symmetry plane A1 have minimal differences or are consistent. That is, if the ear hook 200 is regularly symmetrical, the portions of the ear hook 200 on the two sides of the symmetry plane A1 are consistent. If the ear hook 200 is not strictly symmetrical, the difference between the portions of the ear hook 200 on the two sides of the symmetry plane A1 should be the smallest among various division methods. For example, a projection of the ear hook 200 may be observed on a plane perpendicular to the symmetry plane A1 to distinguish the magnitude of the difference. When the earphone is in a relatively ideal wearing state, the symmetry plane A1 may be substantially parallel to a horizontal plane. It should be noted that “substantially parallel” described in the present disclosure allows an error range of plus or minus 15 degrees. It is easily understood that during use by the user, the earphone may slide under its own gravity, causing the symmetry plane A1 to deviate from the horizontal plane.

In some implementations, the earphone 1 may be another type of earphone that supports being worn on both the left ear and the right ear. It is easily understood that the ear-clip type earphone shown in FIG. 1 is merely an example and should not be construed as limiting the method of some embodiments of the present description.

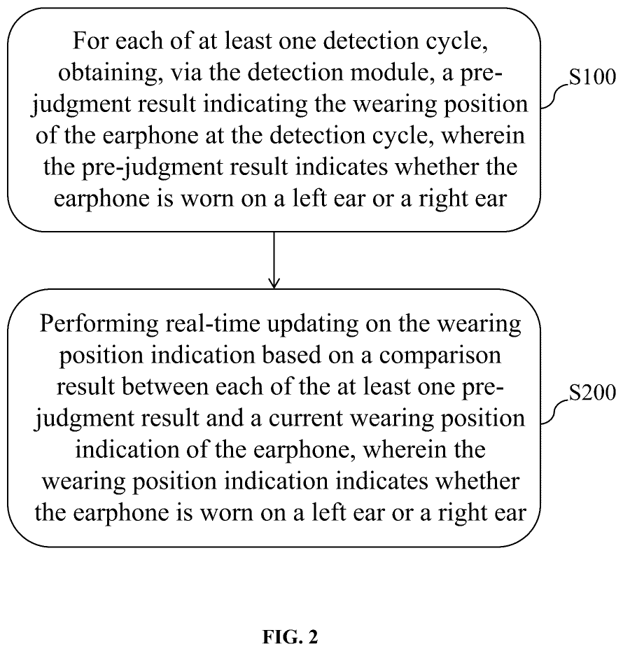

As shown in FIG. 2, FIG. 2 is a flowchart of a detection method according to an embodiment of the present disclosure. The detection method may include the following operations:

In S100, for each of at least one detection cycle, a pre-judgment result indicating the wearing position of the earphone at the detection cycle is obtained via the detection module, wherein the pre-judgment result indicates whether the earphone is worn on a left ear or a right ear.

Each detection cycle corresponds to generation of one pre-judgment result. Duration of each detection cycle is in a range of 50 ms-10 s. For example, the duration of each detection cycle may be 50 ms, 100 ms, 300 ms, 500 ms, 1 s, 3 s, 5 s, or 10 s. The detection module is configured to detect the wearing position of the earphone and output the pre-judgment result for indicating the wearing position of the earphone. The pre-judgment result is configured to indicates whether the earphone is worn on the left ear or the right ear.

In some embodiments, the detection module may include an accelerometer. In this case, operation S100 may be implemented by the following operations.

In S101, the pre-judgment result at the detection cycle is obtained based on at least one set of acceleration values detected by the accelerometer.

The accelerometer has a built-in spatial coordinate system, including an X-axis, a Y-axis, and a Z-axis. The X-axis and the Y-axis may both be substantially parallel to the symmetry plane A1. The Z-axis may be substantially perpendicular to the symmetry plane A1. It should be noted that “substantially parallel” and “substantially perpendicular” described in the present disclosure allow an error range of plus or minus 15 degrees. The accelerometer may detect acceleration components of the earphone in the X-axis direction, the Y-axis direction, and the Z-axis direction.

In some embodiments, within each detection cycle, only one set of acceleration values may be obtained, and the pre-judgment result may be obtained based on the set of acceleration values. In some embodiments, within each detection cycle, a plurality of sets of acceleration values may be obtained, and the pre-judgment result may be obtained based on the plurality of sets of acceleration values, which is beneficial for improving the accuracy of wearing position detection.

In some embodiments, each set of acceleration values may include only the acceleration component in the Z-axis direction. That is, the pre-judgment result may be obtained by using only the acceleration component in the Z-axis direction. The positive or negative value of the acceleration component in the Z-axis direction may, to some extent, reflect the wearing position of the earphone.

Specifically, when the earphone is in a relatively ideal wearing state, the head of the user may have no motion in the vertical direction, and the head of the user may substantially upright. Since the designated coordinate axis Z-axis is substantially perpendicular to the symmetry plane A1, and the symmetry plane A1 is substantially parallel to the horizontal plane in the wearing state of the earphone, an angle between the gravitational acceleration and the Z-axis is relatively small at this time, causing an association between an absolute value of the acceleration component in the Z-axis direction and a value of the gravitational acceleration, such that the absolute value of the acceleration component in the Z-axis direction falls within a preset threshold range.

That is, when the absolute value of the acceleration component in the Z-axis direction is within the preset threshold range, it may be determined that the head of the user does not have vertical movement and is substantially upright. At this time, a positive or negative sign of the acceleration component in the Z-axis direction may effectively indicate the wearing position of the earphone. For example, assuming that the Z-axis is upward when the earphone is worn on the left ear and the Z-axis is downward when the earphone is worn on the right ear. As another example, when the acceleration component in the Z-axis direction is positive, it indicates that the earphone is worn on the right ear, and when the acceleration component in the Z-axis direction is negative, it indicates that the earphone is worn on the left ear. Similarly, assuming that the Z-axis is downward when the earphone is worn on the left ear and the Z-axis is upward when the earphone is worn on the right ear. When the acceleration component in the Z-axis direction is positive, it indicates that the earphone is worn on the left ear, and when the acceleration component in the Z-axis direction is negative, it indicates that the earphone is worn on the right ear.

When the absolute value of the acceleration component in the Z-axis direction is not within the preset threshold range, it indicates that the head of the user may have upward movement or downward movement, or the head may be in a tilted state, for example, the user is lying flat or semi-reclining. At this time, the positive or negative sign of the acceleration component in the Z-axis direction cannot effectively indicate the wearing position of the earphone.

In some embodiments, each set of acceleration values may include an acceleration component in the X-axis direction, an acceleration component in the Y-axis direction, and the acceleration component in the Z-axis direction, to improve accuracy of a pre-judgment result.

This is within a scope easily understood by a person skilled in the art, and details are not repeated here.

In some embodiments, operation S101 may be specifically implemented by including the following operations.

In S1011, at least one set of acceleration values obtained within the detection cycle is input into a trained neural network model to obtain the pre-judgment result.

Specifically, the neural network model may be trained using a calibrated training set. For example, the training set may include a plurality of sets of acceleration values. Each set of acceleration values may include an acceleration component in the X-axis direction, an acceleration component in the Y-axis direction, and an acceleration component in the Z-axis direction. Within each detection cycle, at least one set of acceleration values may be obtained and input into the trained neural network model to obtain the pre-judgment result.

In some embodiments, within each detection cycle, only one set of acceleration values may be obtained. This set of acceleration values may be input into the trained neural network model, and the neural network model performs operations such as convolution and pooling to generate the pre-judgment result. In some embodiments, within each detection cycle, a plurality of sets of acceleration values may be obtained. Inputting the plurality of sets of acceleration values into the trained neural network model increases an amount of input data, which is beneficial for improving accuracy of the pre-judgment result, thereby improving accuracy of wearing position detection.

When it may be determined that the earphone is worn on the left ear based on at least one acceleration value obtained within the detection cycle, the pre-judgment result may be set to indicate the left ear. When it may be determined that the earphone is worn on the right ear based on the at least one acceleration value obtained within the detection cycle, the pre-judgment result may be set to indicate the right ear. When the wearing position of the earphone may not be determined based on the at least one acceleration value obtained within the detection cycle, the pre-judgment result may be set to indicate an unknown state. When the pre-judgment result is set to indicate the left ear or the right ear, the pre-judgment result may be considered valid, i.e., in a valid state. When the pre-judgment result is set to indicate the unknown state, the pre-judgment result may be considered invalid, i.e., not in the valid state.

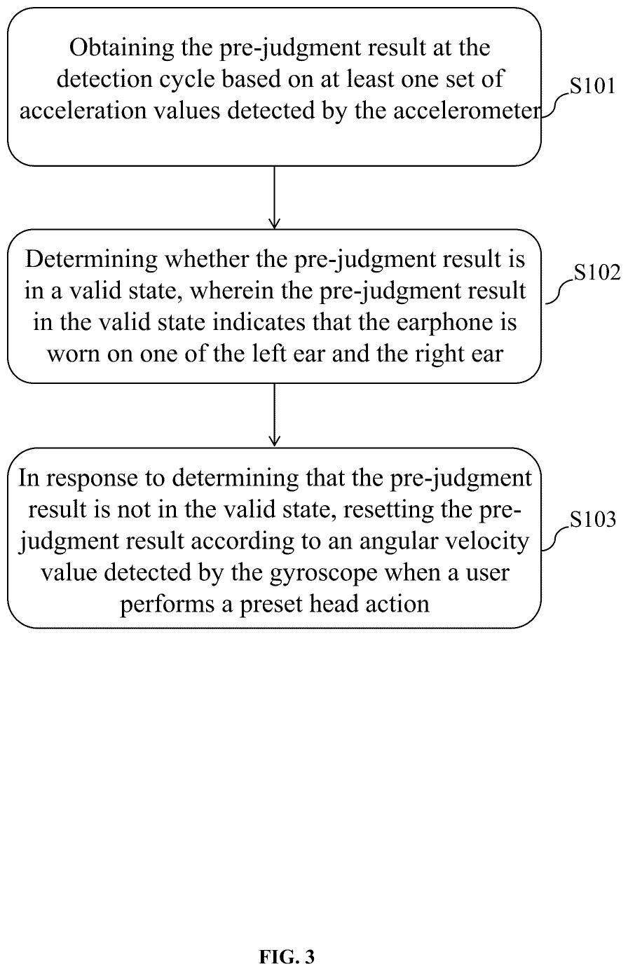

In some embodiments, the detection module may further include a gyroscope. When the pre-judgment result is not in the valid state (i.e., is in unknown state), the pre-judgment result may be reset using the gyroscope. Specifically, as shown in FIG. 3, FIG. 3 is a flowchart of operation S100 according to an embodiment of the present disclosure. After operation S101, operation S100 may further include the following operations.

In S102, it is determined whether the pre-judgment result is in a valid state, wherein the pre-judgment result in the valid state indicates that the earphone is worn on one of the left ear and the right ear.

In S103, in response to determining that the pre-judgment result is not in the valid state, the pre-judgment result is reset according to an angular velocity value detected by the gyroscope when a user performs a preset head action.

The gyroscope may share a same spatial coordinate system with the accelerometer, and may be used to detect an angular velocity component of the earphone rotating around the X-axis, rotating around the Y-axis, and rotating around the Z-axis.

The preset head action may include an action of tilting a head to a left shoulder, an action of tilting the head to a right shoulder, an action of turning the head to the left, an action of turning the head to the right, an action of raising the head upward, or an action of lowering the head downward. The present disclosure does not limit the preset head action, and a person skilled in the art may make a selection according to actual requirements.

When the pre-judgment result is not in the valid state, a voice reminder may be sent to the user to remind the user to perform the preset head action. Of course, other forms of reminders may also be sent to the user to cause the user to perform the preset head action. The present disclosure does not limit this, and a person skilled in the art can make a selection according to actual requirements.

Assume that when the earphone is worn on the left ear, the Z-axis is upward, the X-axis is rightward, and the Y-axis is backward; when the earphone is worn on the right ear, the Z-axis is downward, the X-axis is leftward, and the Y-axis is backward. In this case, if the preset head action is turning the head to the right, and the angular velocity value of rotation around the Z-axis detected by the gyroscope is positive, it indicates that the earphone is worn on the left ear, and the pre-judgment result may be reset to indicate the left ear. If the preset head action is turning the head to the right, and the angular velocity value of rotation around the Z-axis detected by the gyroscope is negative, it indicates that the earphone is worn on the right ear, and the pre-judgment result may be reset to indicate the right ear.

In some embodiments, when the user performs the preset head action, the gyroscope may also determine the wearing position of the earphone through angular velocity components of rotation around the X, Y, and Z axes. Compared with determining the wearing position of the earphone through rotation of a single axis in the above embodiments, determining the wearing position of the earphone through the angular velocity components of the three axes may further improve the accuracy of the wearing position of the earphone. This is within a scope easily understood by a person skilled in the art, and details are not repeated here.

In some embodiments, when the pre-judgment result is not in the valid state, the pre-judgment result is reset based on the angular velocity value detected by the gyroscope when the user performs the preset head action, which is beneficial for improving validity of the pre-judgment result, thereby improving accuracy of wearing position detection.

In some embodiments, when an antenna structure of the earphone is configured so that antenna communication performance of the earphone when worn on the left ear and the right ear are different. For example, radiation performance of an antenna usually has a certain directivity. When the earphone is designed, its radiation performance may be optimized based on the left ear. In this case, a communication performance parameter (e.g., a received signal strength indication (RSSI)) when the earphone is worn on the left ear, is superior than a communication performance parameter when the earphone is worn on the right ear. At this time, the detection module may be used to detect the communication performance parameter of the earphone, thereby obtaining the pre-judgment result for indicating the wearing position of the earphone.

In some embodiments, a speaker of the earphone may emit ultrasonic waves, and when the earphone is worn on the left ear or the right ear, a moment a microphone of the earphone receives the ultrasonic waves or a waveform received by the earphone may differ. At this time, the detection module may be used to detect a difference in the ultrasonic waves received by the microphone of the earphone, thereby obtaining the pre-judgment result for indicating the wearing position of the earphone.

In S200, real-time updating is performed on the wearing position indication based on a comparison result between each of the at least one pre-judgment result and a current wearing position indication of the earphone, wherein the wearing position indication indicates whether the earphone is worn on a left ear or a right ear.

In some embodiments, operation S200 may be implemented by including the following operations.

In S201, among a preset count of consecutive detection cycles, detection cycles whose pre-judgment results are valid and different from the wearing position indication are determined; in response to determining that the count of the determined detection cycles is greater than or equal to a preset count threshold, the wearing position indication is updated to the pre-judgment results of the determined detection cycles, the preset count of the consecutive detection cycles is greater than or equal to the preset count threshold.

The preset count of consecutive detection cycles and the preset count threshold are not limited in the present disclosure, and a person skilled in the art may make a selection according to actual requirements.

For example, the preset count of consecutive detection cycles may refer to five consecutive detection cycles, and “the preset count threshold may be three. Assuming that the current wearing position indication indicates that the wearing position is the left ear, if, among five consecutive detection cycles, three or more detection cycles have the pre-judgment result as the right ear, the wearing position indication is updated from the left ear to the right ear. If, among the five consecutive detection cycles, only one or two detection cycles have the pre-judgment result as the right ear or all five consecutive detection cycles have the pre-judgment result as the left ear, the wearing position indication is not updated.

In some embodiments, by performing a weight judgment on the pre-judgment results of consecutive detection cycles to determine whether to update the wearing position indication, the accuracy of wearing position detection is improved.

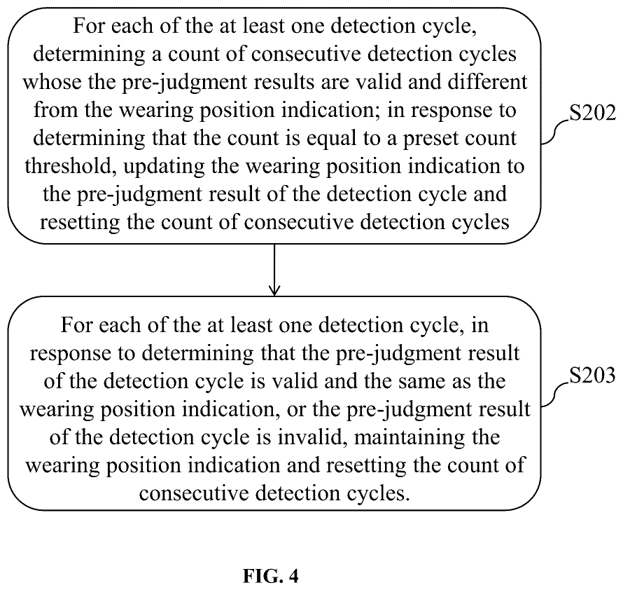

As shown in FIG. 4, FIG. 4 is a flowchart of operation S200 according to an embodiment of the present disclosure. In some embodiments, S200 may be implemented by including the following operations:

In S202, for each of the at least one detection cycle, a count of consecutive detection cycles whose pre-judgment results are valid and different from the wearing position indication is determined; in response to determining that the count is equal to a preset count threshold, the wearing position indication is updated to the pre-judgment result of the detection cycle and the count of consecutive detection cycles is reset.

The preset count threshold is not limited in the present disclosure, and a person skilled in the art may make a selection according to actual requirements.

For example, the preset count threshold may be three. Assuming that the wearing position indicated by the current wearing position indication is the left ear, when a pre-judgment result of the right ear appears, start counting and set the count to 1. If a pre-judgment result of a next detection cycle is the right ear, set the count to 2. If a pre-judgment result of a next detection cycle after that is the right ear, set the count to 3. At this time, the count of consecutive appearances of the right ear is three times, the wearing position indication is updated from the left ear to the right ear, and reset the count of consecutive detection cycles to 0.

In S203, for each of the at least one detection cycle, in response to determining that the pre-judgment result of the detection cycle is valid and the same as the wearing position indication or the pre-judgment result of the detection cycle is invalid, the wearing position indication is maintained and the count of consecutive detection cycles is reset.

For example, the preset count threshold may be three. Assuming that the current wearing position indication is the left ear, when a pre-judgment result of the right ear appears, start counting and set the count to 1. If a pre-judgment result of a next detection cycle is the left ear, reset the count of consecutive detection cycles to 0 and maintain the wearing position indication unchanged.

It should be noted that there is no sequential order between operations S202 and S203.

In some embodiments, when the count of consecutive detection cycles whose pre-judgment results are valid and different from the wearing position indication is equal to the preset count threshold, the wearing position indication is updated, which is beneficial for improving the accuracy of wearing position detection.

In general, the method of some embodiments of the present description differs from related technologies in that, when the earphone is in the wearing state, the wearing position of the earphone is periodically detected at a detection cycle, and the wearing position indication stored in the earphone is updated in real-time. Compared with related technologies, the present disclosure helps reduce the risk of false detection and improve the accuracy of wearing position detection.

It should be noted that the method described in the present disclosure may be periodically executed within a preset time period. For example, in response to the earphone being in the wearing state, timing is started, and the method described above is periodically executed within the preset time period (for example, the duration of the preset time period may be between 20 s and 60 s, e.g., 20 s, 30 s, 40 s, 50 s, 60 s).

The real-time updating described in the present disclosure refers to that the updating of the wearing position indication is continuously performed within the preset time period. For example, when the earphone is placed into the earphone case, the earphone case may set a wearing position indication for the earphone. When the earphone is first worn by a user, the wearing position indication may be updated once based on a pre-judgment result. Subsequently, the detection module continues to be used to obtain a pre-judgment result, and the current wearing position indication is continuously updated based on the pre-judgment result.

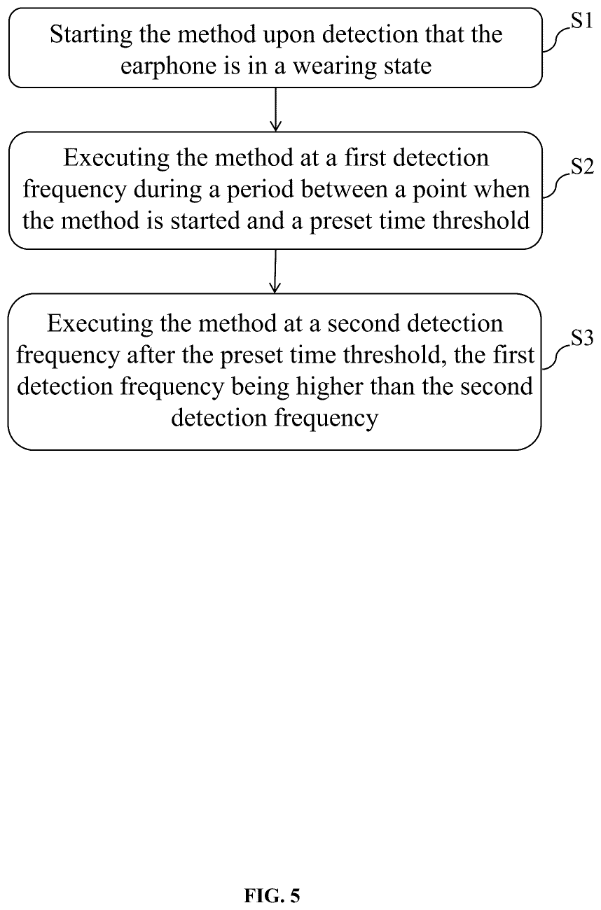

As shown in FIG. 5, FIG. 5 is a flowchart of a detection method according to another embodiment of the present disclosure. In some embodiments, the method further includes:

In S1, the method is started upon detection that the earphone is in a wearing state.

In some embodiments, execution of the method described above may also be started in response to the earphone being taken out of the earphone case. The present disclosure does not impose limitations on this, and those skilled in the art may make selections based on actual requirements.

In S2, the method is executed at a first detection frequency during a period between a point when the method is started and a preset time threshold.

The present disclosure does not impose limitations on the the preset time threshold, and those skilled in the art may make selections based on actual requirements.

In S3, the method is executed at a second detection frequency after the preset time threshold, the first detection frequency being higher than the second detection frequency.

In some embodiments, before the preset time threshold, the method described above is executed at a higher detection frequency. After the preset time threshold, the method described above is executed at a lower detection frequency. This helps reduce device power consumption while ensuring the accuracy of wearing position detection.

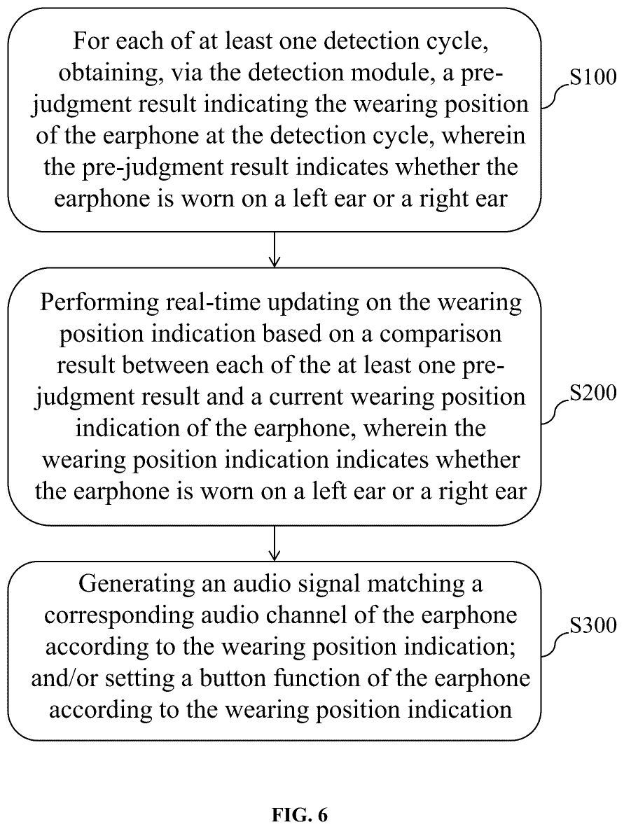

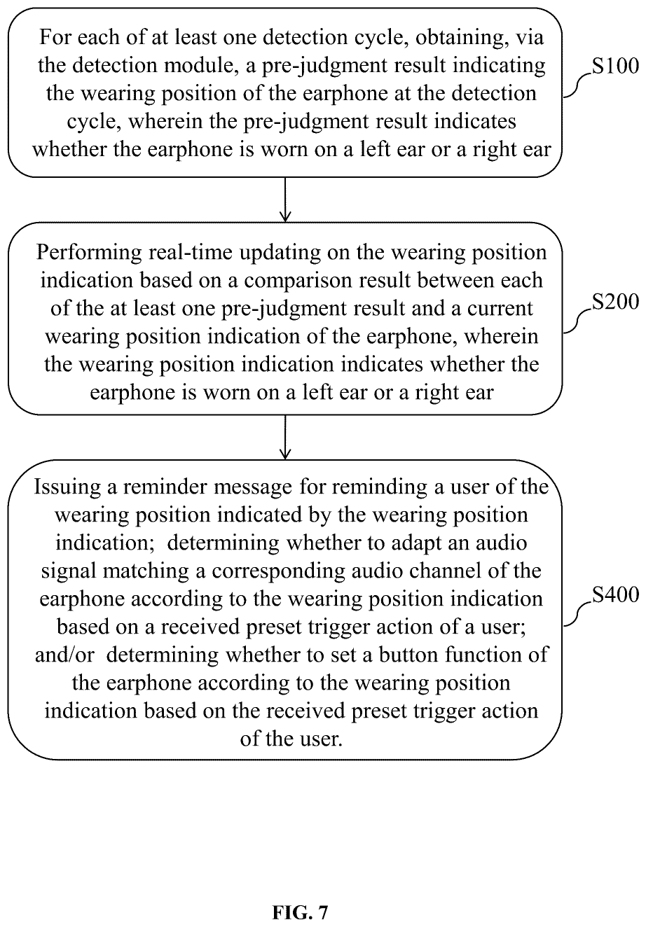

As shown in FIG. 6, FIG. 6 is a flowchart of a detection method according to another embodiment of the present disclosure. In some embodiments, after S200, the method further includes the following operation.

In S300, an audio signal matching a corresponding audio channel of the earphone is generated according to the wearing position indication; and/or a button function of the earphone is set according to the wearing position indication.

For example, when the wearing position indication indicates that the earphone is worn on the left ear, a left channel audio signal may be adapted for the earphone. Similarly, when the wearing position indication indicates that the earphone is worn on the right ear, a right channel audio signal may be adapted for the earphone, thereby improving the user experience.

In some embodiments, the earphone is further provided with a button, which may be a mechanical button. The button may also be a touch button. The button function may be different when the earphone is worn on the left ear or the right ear. For example, when the earphone is worn on the left ear, the button on it may be used to switch playback tracks. When the earphone is worn on the right ear, the button on it may be used to adjust the volume. In such cases, the button function of the earphone may be set based on the current wearing position indication of the earphone, thereby improving the user experience.

As shown in FIG. 7, FIG. 7 is a flowchart of a detection method according to another embodiment of the present disclosure. In some embodiments, after operation S200, the method further includes the following operation.

In S400, a reminder message for reminding a user of the wearing position indicated by the wearing position indication is issued; it is determined whether to adapt an audio signal matching a corresponding audio channel of the earphone according to the wearing position indication based on a received preset trigger action of a user; and/or it is determined whether to set a button function of the earphone according to the wearing position indication based on the received preset trigger action of the user.

For example, the reminder message may be issued in the form of voice, used to announce the wearing position indicated by the current wearing position indication to the user. In some embodiments, upon receiving the reminder message, the user may independently judge whether the wearing position indicated by the wearing position indication is accurate. If it is accurate, the user may perform the preset trigger action on the earphone, such as an action for transmitting a mechanical signal, an action for transmitting an optical signal, or an action for transmitting an electrical signal, to cause the earphone to adapt the audio signal matching the corresponding audio channel of the earphone based on the wearing position indicated by the wearing position indication and/or set the button function of the earphone based on the wearing position indicated by the wearing position indication.

In some embodiments, the user may independently judge whether the wearing position indicated by the wearing position indication is accurate. If it is not accurate, the user can perform the preset trigger action on the earphone to cause the earphone not to perform the step of adapting the audio signal matching the corresponding audio channel of the earphone based on the wearing position indicated by the wearing position indication and/or not to perform the step of setting the button function of the earphone based on the wearing position indicated by the wearing position indication. The present disclosure does not impose limitations on this, and those skilled in the art may make selections based on actual requirements.

In some embodiments, the user may be provided with an opportunity to independently judge whether the wearing position indicated by the wearing position indication is accurate. In this way, even if the current wearing position indication is incorrect, it can be promptly identified by the user, thereby avoiding impact on the user experience.

In some embodiments, there is a pair of earphones. The method further includes the following operation.

In S500, in response to determining that the current wearing position indications of the pair of earphones indicate that the pair of earphones are worn on the same ear for a predetermined time, a reset reminder is generated.

For example, if the user wears the two earphones on the left ear and the right ear respectively, but the current wearing position indications of both earphones indicate that they are worn on the left ear, this indicates that at least one of the wearing position indications is incorrect. In this case, a reset reminder may be generated to promptly identify when the wearing position indicated by the wearing position indication is incorrect, thereby avoiding impact on the user experience.

In some embodiments, there is a pair of earphones. The method further includes the following operation.

In S600, in response to determining that the current wearing position indications of the pair of earphones indicate that the pair of earphones are worn on the same ear, and a generation time of the current wearing position indication of one of the pair of earphones is earlier than a generation time of the current wearing position indication of the other of the pair of earphones, the wearing position indication of the one of the pair of earphones is maintained unchanged and the wearing position indication of the other of the pair of earphones is reset.

For example, if the current wearing position indications of both earphones indicate that they are worn on the left ear, and the generation time of the current wearing position indication of one earphone is earlier than that of the other earphone, that is, the current wearing position indication of the one earphone was generated earlier, and the current wearing position indication of the other earphone was generated later. In this case, for the earphone whose wearing position indication was generated earlier, its wearing position indication may be maintained as the left ear. For the earphone whose wearing position indication was generated later, its wearing position indication may be reset to the right ear. Subsequently, the audio signal matching the corresponding audio channel may be further adapted according to the respective wearing position indication of each of the two earphones, and/or the button function may be adapted according to the respective wearing position indication of each of the two earphones. In this way, when the user wears the two earphones on the left ear and the right ear, respectively, it helps avoid the situation where both earphones play audio of the same channel, thereby improving the user experience.

In some embodiments, the method further includes the following operation.

In S700, in response to determining that the earphone is placed into an earphone compartment of an earphone case, the wearing position indication is reset by the earphone case.

The earphone case may include a left earphone compartment and a right earphone compartment. When the earphone is placed into the left earphone compartment, the earphone case may reset the wearing position indication of the earphone to the left ear. When the earphone is placed into the right earphone compartment, reset the wearing position indication of the earphone to the right ear. When the user takes the earphones out of the earphone case again, the user habitually wears the earphone from the left earphone compartment on the left ear, and wears the earphone from the right earphone compartment on the right ear. In this way, after entering the wearing state, the wearing position indications of both earphones may correctly indicate the wearing positions of the earphones, thereby enabling rapid configuration of the audio signal matching the corresponding audio channel and button function for the earphones, which helps improve the user experience.

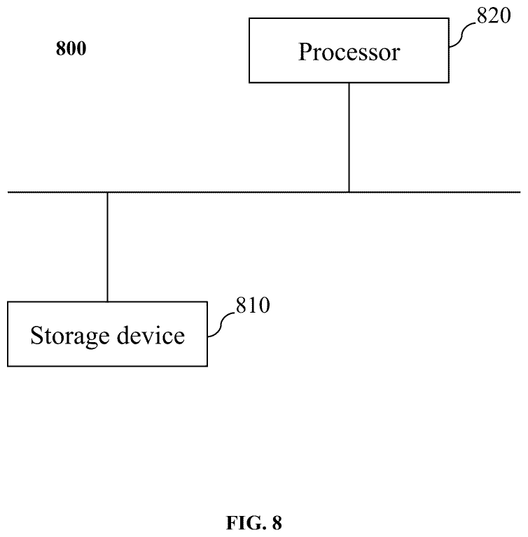

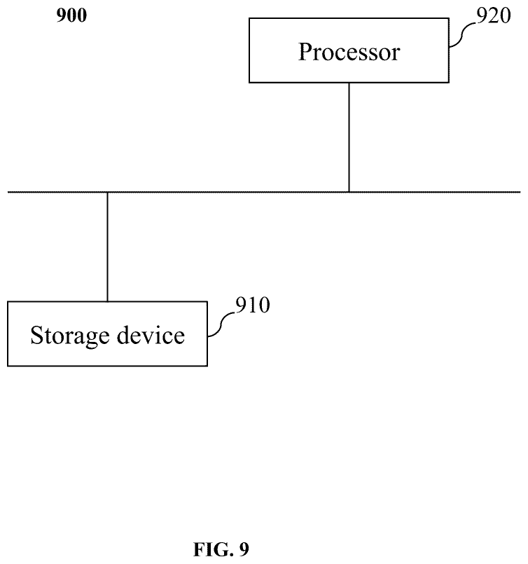

Another aspect of the present disclosure further provides an earphone 800. Please refer to FIG. 8. FIG. 8 is a block diagram of an earphone according to an embodiment of the present disclosure. The earphone 800 may include a storage device 810, a processor 820, and a computer program stored on the storage device 810 and executable on the processor 820. The processor 820, when executing the computer program, implements any of the methods described above.

The processor 820 may also be referred to as a CPU (Central Processing Unit). The processor 820 may be an integrated circuit chip with signal processing capabilities. The processor 820 may also be a general-purpose processor, a digital signal processor (DSP), an application-specific integrated circuit (ASIC), a field-programmable gate array (FPGA) or other programmable logic device, discrete gate or transistor logic device, or discrete hardware component. The general-purpose processor may be a microprocessor, or the processor 820 may also be any conventional processor, etc.

The storage device 810 may include random access memory (RAM), read-only memory (ROM), flash memory, erasable programmable read-only memory (EPROM), electrically erasable programmable read-only memory (EEPROM), registers, hard disks, removable disks, CD-ROM, etc. The storage device 810 may store program data. The program data may include, for example, a single instruction, or a plurality of instructions, and may be distributed across several different code segments, across different programs, and across a plurality of storage devices. The storage device 810 may be coupled to the processor 820 to enable the processor 820 to read/write information from/to the storage device 810. Of course, the storage device 810 may be integrated into the processor 820. The present disclosure does not impose limitations on this, and those skilled in the art may make selections based on actual requirements.

Another aspect of the present disclosure further provides an electronic device 900. Please refer to FIG. 9. FIG. 9 is a block diagram of an electronic device according to an embodiment of the present disclosure. The electronic device 900 includes a storage device 910, a processor 920, and a computer program stored on the storage device 910 and executable on the processor 920. The processor 920, when executing the computer program, implements any of the methods described above.

The electronic device 900 may be a mobile phone, a tablet, or a computer that communicates with the earphone 800. The present disclosure does not impose limitations in this regard, and those skilled in the art may make selections based on actual requirements.

The processor 920 may also be referred to as a central processing unit (CPU). The processor 920 may be an integrated circuit chip with signal processing capabilities. The processor 920 may also be a general-purpose processor, a digital signal processor (DSP), an application-specific integrated circuit (ASIC), a field-programmable gate array (FPGA), or other programmable logic device, discrete gate or transistor logic device, or discrete hardware component. The general-purpose processor may be a microprocessor, or the processor 920 may be any conventional processor.

The storage device 910 may include random access memory (RAM), read-only memory (ROM), flash memory, erasable programmable read-only memory (EPROM), electrically erasable programmable read-only memory (EEPROM), registers, a hard disk, a removable disk, a CD-ROM, etc. The storage device 910 may store program data. The program data may include, for example, a single instruction or a plurality of instructions, and may be distributed across several different code segments, across different programs, and across a plurality of storage devices. The storage device 910 may be coupled to the processor 920 to enable the processor 920 to read/write information from/to the storage device 910. Certainly, the storage device 910 may be integrated into the processor 920. The present disclosure does not impose limitations in this regard, and those skilled in the art may make selections based on actual requirements.

In the several embodiments provided in the present disclosure, it should be understood that the disclosed method may be implemented in other manners. As an example, the earphone/electronic device embodiments described above are merely illustrative. As another example, the division of modules or units is merely a division of logical functions. In actual implementation, there may be other division manners. As another example, a plurality of units or components may be combined or integrated into another system, or some features may be omitted or not performed. As another point, the mutual couplings or direct couplings or communication connections shown or discussed may be indirect couplings or communication connections through some interfaces, devices, or units, and may be electrical, mechanical, or in other forms.

Units described as separate components may or may not be physically separate.

Components displayed as units may or may not be physical units, i.e., they may be located in one place or distributed across a plurality of network units. Some or all of the units may be selected according to actual requirements to achieve the objectives of the embodiments of the present disclosure.

In addition, the functional units in the various embodiments of the present disclosure may be integrated into one processing unit, or each unit may exist alone physically, or two or more units may be integrated into one unit. The above integrated units may be implemented in the form of hardware or in the form of software functional units.

The above descriptions are merely some embodiments of the present disclosure and are not intended to limit the scope of protection of the present disclosure. Any equivalent device or equivalent process transformation made based on the content of the specification and drawings of the present disclosure, or direct or indirect application in other related technical fields, shall similarly fall within the patent protection scope of the present disclosure.

What is claimed is:

1. A method for detecting a wearing position of an earphone, wherein the earphone is provided with a detection module and stores a wearing position indication, and the method comprises:
for each of at least one detection cycle, obtaining, via the detection module, a pre-judgment result indicating the wearing position of the earphone at the detection cycle, wherein the pre-judgment result indicates whether the earphone is worn on a left ear or a right ear; and
performing real-time updating on the wearing position indication based on a comparison result between each of the at least one pre-judgment result and a current wearing position indication of the earphone, wherein the wearing position indication indicates whether the earphone is worn on a left ear or a right ear.

2. The method according to claim 1, wherein the detection module comprises an accelerometer, and
the obtaining, via the detection module, a pre-judgment result indicating the wearing position of the earphone at the detection cycle comprises:
obtaining the pre-judgment result at the detection cycle based on at least one set of acceleration values detected by the accelerometer.

3. The method according to claim 2, wherein the earphone includes an ear hook having a symmetry plane arranged along a length direction of the ear hook, and each set of the at least one set of acceleration values includes an acceleration component in a Z-axis direction, the Z-axis direction being perpendicular to the symmetry plane.

4. The method according to claim 3, wherein each set of the at least one set of acceleration values further includes an acceleration component in an X-axis direction and an acceleration component in a Y-axis direction, the X-axis and the Y-axis being parallel to the symmetry plane.

5. The method according to claim 2, wherein the detection module further comprises a gyroscope;
the obtaining, via the detection module, a pre-judgment result indicating the wearing position of the earphone at the detection cycle further comprises:
determining whether the pre-judgment result is in a valid state, wherein the pre-judgment result in the valid state indicates that the earphone is worn on one of the left ear and the right ear; and
in response to determining that the pre-judgment result is not in the valid state, resetting the pre-judgment result according to an angular velocity value detected by the gyroscope when a user performs a preset head action.

6. The method according to claim 1, wherein the obtaining, via the detection module, a pre-judgment result indicating the wearing position of the earphone at the detection cycle further comprises:
obtaining, via the detection module, the pre-judgment result indicating the wearing position of the earphone at the detection cycle by detecting ultrasonic waves received by a microphone of the earphone.

7. The method according to claim 1, wherein the method is started upon detection that the earphone is in a wearing state,
the method is executed at a first detection frequency during a period between a point when the method is started and a preset time threshold, and
the method is executed at a second detection frequency after the preset time threshold, the first detection frequency being higher than the second detection frequency.

8. The method according to claim 1, wherein the performing real-time updating on the wearing position indication based on a comparison result between each of the at least one pre-judgment result and a current wearing position indication of the earphone comprises:
determining, among a preset count of consecutive detection cycles, detection cycles whose the pre-judgment results are valid and different from the wearing position indication;
in response to determining that the count of the determined detection cycles is greater than or equal to a preset count threshold, updating the wearing position indication to the pre-judgment results of the determined detection cycles, wherein the preset count of the consecutive detection cycles is greater than or equal to the preset count threshold.

9. The method according to claim 1, wherein the performing real-time updating on the wearing position indication based on a comparison result between each of the at least one pre-judgment result and a current wearing position indication of the earphone comprises:
for each of the at least one detection cycle,
determining a count of consecutive detection cycles whose the pre-judgment results are valid and different from the wearing position indication;
in response to determining that the count is equal to a preset count threshold, updating the wearing position indication to the pre-judgment result of the detection cycle and resetting the count of consecutive detection cycles.

10. The method according to claim 9, wherein the performing real-time updating on the wearing position indication based on a comparison result between each of the at least one pre-judgment result and a current wearing position indication of the earphone further comprises:
for each of the at least one detection cycle,
in response to determining that the pre-judgment result of the detection cycle is valid and the same as the wearing position indication, or the pre-judgment result of the detection cycle is invalid, maintaining the wearing position indication and resetting the count of consecutive detection cycles.

11. The method according to claim 2, wherein the obtaining the pre-judgment result at the detection cycle based on at least one set of acceleration values detected by the accelerometer comprises:
obtaining the pre-judgment result by inputting the at least one set of acceleration values obtained within the detection cycle into a trained neural network model.

12. The method according to claim 1, wherein the method further comprises:
in response to determining that the earphone is placed into an earphone compartment of an earphone case, resetting, by the earphone case, the wearing position indication.

13. The method according to claim 12, wherein the earphone case includes a left earphone compartment and a right earphone compartment, and the in response to determining that the earphone is placed into an earphone compartment of an earphone case, resetting, by the earphone case, the wearing position indication includes:
resetting the wearing position indication of the earphone to the left ear when it is placed into the left earphone compartment; or
resetting the wearing position indication of the earphone to the right ear when it is placed into the right earphone compartment.

14. The method according to claim 1, wherein there is a pair of earphones, and the method further comprises:
in response to determining that the current wearing position indications of the pair of earphones indicate that the pair of earphones are worn on the same ear for a predetermined time, generating a reset reminder.

15. The method according to claim 1, wherein there is a pair of earphones, and the method further comprises:
in response to determining that the current wearing position indications of the pair of earphones indicate that the pair of earphones are worn on the same ear, and a generation time of the current wearing position indication of one of the pair of earphones is earlier than a generation time of the current wearing position indication of the other of the pair of earphones, maintaining the wearing position indication of the one of the pair of earphones unchanged and resetting the wearing position indication of the other of the pair of earphones.

16. The method according to claim 1, wherein duration of each detection cycle is in a range of 50 ms-10 s.

17. The method according to claim 1, wherein the method further comprises:
generating an audio signal matching a corresponding audio channel of the earphone according to the wearing position indication; and/or
setting a button function of the earphone according to the wearing position indication.

18. The method according to claim 1, wherein the method further comprises:
issuing a reminder message for reminding a user of the wearing position indicated by the wearing position indication;
determining whether to adapt an audio signal matching a corresponding audio channel of the earphone according to the wearing position indication based on a received preset trigger action of a user; and/or
determining whether to set a button function of the earphone according to the wearing position indication based on the received preset trigger action of the user.

19. An earphone, wherein the earphone comprises a processor and a storage device, the storage device stores a computer program, and the processor is configured to execute the computer program to implement the method according to claim 1.

20. An electronic device, wherein the electronic device is configured to communicate with an earphone and comprises a processor and a storage device, the storage device stores a computer program, and the processor is configured to execute the computer program to implement the method according to claim 1.
